(19) United States
(12) Patent Application Publication
(10) Pub. No.: US 2024/0003787 A1
(43) Pub. Date: Jan. 4, 2024

(54) METHOD OF STAINING BIOLOGICAL SAMPLE

(71) Applicant: CANON KABUSHIKI KAISHA, Tokyo (JP)

(72) Inventors: AKIKO TOMINAGA, Kanagawa (JP); TOSHIKAZU ONISHI, Kanagawa (JP); MAMIKO KAJI, Kanagawa (JP); YOSHIYUKI KANEKO, Kanagawa (JP)

(21) Appl. No.: 18/342,093

(22) Filed: Jun. 27, 2023

(30) Foreign Application Priority Data
Jul. 1, 2022 (JP) 2022-107379
Jun. 23, 2023 (JP) 2023-103687

(51) Int. Cl. G01N 1/30

(52) U.S. Cl. CPC G01N 1/30; G01N 2001/307; G01N 2001/302

(57) ABSTRACT

The method of staining a biological sample includes: a first liquid application step of applying a first liquid onto one of a biological sample or a substrate on which the biological sample is placed, the first liquid containing a water-repellent component and being aqueous; a second liquid application step of applying a second liquid onto one of the biological sample or the substrate, the second liquid containing a thickening component and being aqueous; and a staining solution application step of applying a staining solution for staining the biological sample. The first liquid and the second liquid are applied so as to overlap each other at least partially, to thereby produce a mixed liquid. The first liquid application step and the second liquid application step include applying the first liquid and the second liquid so that the mixed liquid surrounds a region for holding the staining solution.

### BACKGROUND OF THE INVENTION

### Field of the Invention

The present invention relates to a method of staining a biological sample in staining of a pathological specimen or the like, specifically, dye staining such as hematoxylin-eosin (HE) staining, immunostaining, or staining in in situ hybridization or the like.

### Description of the Related Art

Pathology deals with an examination related to a disease. Staining with a dye such as HE staining, immunostaining, or staining in in situ hybridization is often required in pathology as an important examination for determining a therapeutic strategy. In a pathological examination, a sample is obtained by attaching cells or a tissue fragment removed from a living body onto a substrate such as a slide glass. After that, the cells or the tissue fragment is stained by being brought into contact with a predetermined staining solution.

The staining solution to be used in a pathological examination is expensive. In particular, an antibody to be used for immunostaining and a probe to be used for in situ hybridization are very expensive, and hence a staining solution containing the antibody or the probe is often used in a small amount. Accordingly, there is a demand that the staining solution be reliably placed on an object to be stained.

As a solution to such problem, there is known a pen (PAP pen) for forming a frame having water repellency on a slide glass. When a frame having water repellency is formed with the PAP pen to suppress an outflow of the staining solution to a portion where the object to be stained is absent, staining with a small amount of the staining solution can be efficiently performed.

In addition, in Japanese Patent Application Laid-Open No. 2006-105653, there is a disclosure of a tissue adhesive sheet. There is a disclosure that, when one slide glass is partitioned with the tissue adhesive sheet, many kinds of staining can be performed on the one slide glass.

### SUMMARY OF THE INVENTION

The present invention is directed to provide a method of staining a biological sample, which can precisely create a frame for holding a staining solution at any position, and further, can heighten the frame after its creation.

According to one aspect of the present invention, there is provided a method of staining a biological sample including: a first liquid application step of applying a first liquid onto one of a biological sample or a substrate on which the biological sample is placed, the first liquid containing a water-repellent component and being aqueous; a second liquid application step of applying a second liquid onto one of the biological sample or the substrate, the second liquid containing a thickening component and being aqueous; and a staining solution application step of applying a staining solution for staining the biological sample, wherein the first liquid and the second liquid are applied so as to overlap each other at least partially, to thereby produce a mixed liquid, wherein the thickening component is a component for increasing a viscosity of the mixed liquid, and wherein the first liquid application step and the second liquid application step include applying the first liquid and the second liquid so that the mixed liquid surrounds a region for holding the staining solution.

Further features of the present invention will become apparent from the following description of exemplary embodiments.

### DESCRIPTION OF THE EMBODIMENTS

In a PAP pen, a water-repellent component is dissolved with an organic solvent to be used as an ink. Accordingly, even when a frame is drawn twice in a superimposed manner with the PAP pen, the frame cannot be heightened because the frame formed in the first stroke is dissolved by the organic solvent in the ink at the time of the formation of the second frame. Accordingly, the PAP pen is not applicable to a case in which the surface tension of a staining solution is low, and a case in which the concentration of the staining solution is low, and hence it is desired to increase the amount of the staining solution. Thus, the use of the PAP pen has been sometimes limited. In addition, the ink of the PAP pen is liquid and spreads on a slide glass, and hence it has been difficult to create a precise frame. Accordingly, it has been difficult to increase the number of kinds of staining to be performed with one slide glass.

The tissue adhesive sheet described in Japanese Patent Application Laid-Open No. 2006-105653 can form a precise frame, but is attached to a slide glass having a specimen placed thereon after a region for holding a staining solution has been partitioned into a specific pattern in advance. Accordingly, there has been a problem in that the frame cannot be set to any position while the position and number of specimens on the slide glass are checked.

The present invention is described in detail below by taking an exemplary embodiment.

The inventors made investigations for a method by which a frame having water repellency (hereinafter sometimes referred to as “water-repellent frame”) for surrounding a staining solution can be created at any position. The method involving using the PAP pen has an advantage in that the water-repellent frame can be formed at any position. However, as described above, in the PAP pen, the water-repellent component for forming a water-repellent frame is dissolved in an organic solvent. Accordingly, there has been a problem in that, even when the frame is drawn in a superimposed manner with the PAP pen, the frame cannot be heightened because the water-repellent component for forming the frame is dissolved by the organic solvent when drawn in a superimposed manner. In view of this, in order to prevent the water-repellent component from being dissolved by the medium even when the frame is drawn in a superimposed manner in order to be heightened, the inventors used an aqueous medium instead of the organic solvent as the medium for dispersing the water-repellent component, and investigated the creation of a water-repellent frame with the thus obtained liquid containing the water-repellent component.

When an aqueous liquid is used as the medium into which the water-repellent component is incorporated, even in a case in which the liquid containing the water-repellent component is applied again onto a once-created water-repellent frame, the already formed water-repellent frame can be prevented from being dissolved by the medium. Thus, the water-repellent frame can be heightened by being formed in a superimposed manner, thus being applicable even to the case in which the surface tension of the staining solution is low, and the case in which the staining solution is thin, and hence it is desired to increase the amount of the staining solution.

However, when a water-repellent frame was formed on a slide glass by using the aqueous liquid containing the water-repellent component, the portion where the liquid had been applied spread on the slide glass, and hence a precise frame was not able to be created. A slide glass to which cells or a tissue is to be attached is subjected to hydrophilic treatment in order to reduce detachment in a staining step. Conceivably for this reason, the applied liquid spread.

In addition, after the aqueous liquid containing the water-repellent component had been dried, the frame oozed with the staining solution at the time of its application, failing to exhibit a sufficient function as a frame for suppressing the outflow of the staining solution. This is conceivably because a component in the water-repellent frame was redispersed by the staining solution.

Further, when the frame formed with the aqueous liquid containing the water-repellent component is dried by heating in order to exhibit water repellency, an object to be stained, such as cells or a tissue, is also dried. Accordingly, the drying of the object to be stained influenced stainability in some cases depending on the staining step.

In view of the foregoing, the inventors have investigated a technique capable of creating a precise water-repellent frame without the spread of the aqueous liquid containing the water-repellent component on the slide glass. The inventors have further investigated a technique for imparting a function as a water-repellent frame without performing drying by heating. In order to satisfy those requirements, the inventors have investigated the application of an aqueous liquid containing the water-repellent component and a liquid for increasing the viscosity of the aqueous liquid containing the water-repellent component. Further, the inventors have further made extensive investigations for a combination of components that can sufficiently suppress the outflow of the staining solution, and as a result, have reached the present invention.

That is, a method of staining a biological sample according to the present invention includes a first liquid application step, a second liquid application step, and a staining solution application step. In the first liquid application step, a first liquid containing a water-repellent component and being aqueous is applied onto a biological sample or a substrate on which the biological sample is placed. In addition, in the second liquid application step, a second liquid containing a thickening component and being aqueous is applied onto the biological sample or the substrate. In addition, in the staining solution application step, a staining solution for staining the biological sample is applied. The first liquid and the second liquid are applied so as to overlap each other at least partially, to thereby produce a mixed liquid. The thickening component is a component for increasing the viscosity of the mixed liquid. Further, the first liquid application step and the second liquid application step include applying the first liquid and the second liquid so that the mixed liquid surrounds a region for holding the staining solution.

The mixed liquid generated by mixing the first liquid containing water-repellent component and the second liquid containing a thickening component results in having a high viscosity. Therefore, a precise water-repellent frame with high wall can be produced at any intended positions on a biological sample or a substrate, and as a result, even in the case that a surface tension of a staining solution is low and the case that a volume of a staining solution is large, the staining solution became possible to be held inside the water-repellent frame.

As the biological sample, for example, cultured cells, bodily fluid (such as blood, serum, blood plasma, cerebrospinal fluid, sweat, saliva, and urine), hair, excrement, organs, and tissue, or plants and animals themselves, or a sample prepared by fixing thereof followed by embedding in paraffin, and dried body thereof can be mentioned.

Components of the first liquid and the second liquid that are constituents of the present invention are described below.

<First Liquid Containing Water-Repellent Component and being Aqueous>

The first liquid containing a water-repellent component and being aqueous is a liquid obtained by dispersing the water-repellent component in an aqueous liquid. A surfactant, a polymeric dispersant, or the like may be used to disperse the water-repellent component in the aqueous liquid. When a frame for surrounding the staining solution is made water-repellent by the water-repellent component contained in the first liquid, the staining solution can be suppressed from outflowing beyond the frame to the outside of the frame, and from mixing with another staining solution outside the frame.

(Water-Repellent Component)

As the water-repellent component, there is preferably used any one kind selected from the group consisting of: an alkyl ketene dimer; an alkenylsuccinic anhydride; rosin; a wax; and polymeric resins, such as a cationic resin and an anionic resin. However, the water-repellent component is not limited to those materials. Any material that exhibits water repellency in a water-repellent frame may be used as the water-repellent component. In addition, the water-repellent components may be used alone or in combination thereof.

In the present invention, the water-repellent component is present in the aqueous liquid by being dispersed in a state of particles. The volume-average particle diameter of the dispersed particles of the water-repellent component is preferably 10 nm or more and 1,000 nm or less. In the present invention, the volume-average particle diameter is a volume-based 50% cumulative particle diameter (D₅₀).

In the present invention, the D₅₀ of dispersed particles of the water-repellent component may be measured by the following method. Ion-exchanged water was added to the first liquid containing the dispersed particles of the water-repellent component to prepare a sample having a solid matter (dispersed particles) content of 1.0% by mass. The prepared sample is measured for its particle diameter using a particle size analyzer based on a dynamic light scattering method such as UPA-EX150 (manufactured by Nikkiso Co., Ltd.) under the following measurement conditions: SetZero: 30 seconds, number of times of measurement: 3, measurement time: 180 seconds, and refractive index: 1.5. As well as in the case that the second liquid contains a water-repellent component, the volume-average particle diameter of the dispersed particles of the water-repellent component can be measured by the same method as for the first liquid.

[Alkyl Ketene Dimer]

The “alkyl ketene dimer” is widely used as a so-called sizing agent preventing ink from soaking into paper using wood pulp as its subject fiber.

The kind of the alkyl ketene dimer is not particularly limited, but is preferably an alkyl ketene dimer obtained by a fatty acid having 8 to 24 carbon atoms as a raw material, more preferably an alkyl ketene dimer obtained by a fatty acid having 16 to 18 carbon atoms as a raw material. When the number of carbon atoms of the fatty acid serving as a raw material is 8 or more, a water-repellent effect in a water-repellent frame can be obtained at a high level. In addition, when the number of carbon atoms of the fatty acid serving as a raw material is 24 or less, the dispersion stability of the alkyl ketene dimer in an aqueous liquid can be made high.

It is preferred in terms of practicality that the alkyl ketene dimer be used for the preparation of the first liquid in a state of being dispersed in an aqueous liquid. Specifically, as a method of preparing a dispersion liquid, there may be given a method involving adding the alkyl ketene dimer to an aqueous liquid and then emulsifying the mixture through use of an emulsifying apparatus, such as a universal homogenizer, a homomixer, an ultrasonic emulsifying machine, a household mixer, or a homogenizer. At the time of the emulsification, a surfactant or a polymeric dispersant is preferably used as an emulsifying agent. Those emulsifying agents may be used alone or in combination thereof.

Specifically, AD1606, AD1608, AD1638, and SE2380 (each of which is manufactured by Seiko PMC Corporation), Sizepine K-903 and Sizepine K-287 (each of which is manufactured by Arakawa Chemical Industries, Ltd.), and the like may each be used as the alkyl ketene dimer.

[Alkenylsuccinic Anhydride]

The “alkenylsuccinic anhydride” is widely used as a so-called sizing agent preventing ink from soaking into paper using wood pulp as its subject fiber as with the alkyl ketene dimer.

The kind of the alkenylsuccinic anhydride is not particularly limited. However, the alkenyl group of the alkenylsuccinic anhydride has preferably 8 to 22 carbon atoms, more preferably 16 to 18 carbon atoms. When the number of carbon atoms is 8 or more, a water-repellent effect in a water-repellent frame can be obtained at a high level. In addition, when the number of carbon atoms is 22 or less, the dispersion stability of the alkenylsuccinic anhydride can be made high.

It is preferred in terms of practicality that the alkenylsuccinic anhydride be used for the preparation of the first liquid in a state of being dispersed in an aqueous liquid. Specifically, as a method of preparing a dispersion liquid, there may be given a method involving adding the alkenylsuccinic anhydride to an aqueous liquid and then emulsifying the mixture through use of an emulsifying apparatus, such as a universal homogenizer, a homomixer, an ultrasonic emulsifying machine, a household mixer, or a homogenizer. At the time of the emulsification, a surfactant or a polymeric dispersant is preferably used as an emulsifying agent. Those emulsifying agents may be used alone or in combination thereof.

Specific examples of the alkenyl succinic anhydride include Sizepine SA-864 (manufactured by Arakawa Chemical Industries, Ltd.) and AS1532 (manufactured by Seiko PMC Corporation).

[Rosin]

The “rosin” is a natural resin containing rosin acid as a main component. In the present invention, the water-repellent component preferably includes rosin as rosin-based resin particles in an aqueous liquid. As a rosin-based resin for forming the rosin-based resin particles, there are given various known rosin-based resins including: rosins including raw material rosins, such as gum rosin, wood rosin, and tall oil rosin, disproportionated products of the raw material rosins, stabilized rosins obtained by subjecting the raw material rosins to hydrogenation treatment, and polymerized rosins; and esterified products of the rosins, phenol-modified products of the rosins, and unsaturated acid-modified rosins.

The rosin-based resin particles are preferably used for the preparation of the first liquid in the form of a rosin-based resin particle dispersion in which the rosin-based resin particles are dispersed in an aqueous liquid. In addition, the rosin-based resin particle dispersion is preferably formed by dispersing the rosin-based resin particles with an emulsifying agent. The emulsifying agent is not particularly limited, and for example, a known emulsifying agent may be used. The kind of the emulsifying agent is preferably selected in consideration of the stability of the dispersion state of the rosin-based resin particles in the first liquid.

The emulsifying agent may be any of a low-molecular-weight compound and a polymer compound as long as the emulsifying agent has an emulsifying ability. Specific examples of the emulsifying agent may include: anionic emulsifying agents, such as a carboxylic acid salt, a sulfonic acid salt, and a sulfuric acid ester salt; and nonionic emulsifying agents including a polyoxyethylene alkyl ether.

In the present invention, the rosin-based resin particles may be a product obtained by emulsifying one of the rosin-based resins given as examples above alone or a mixture of a plurality of kinds of the rosin-based resins. In addition, the rosin-based resin particles may be a product obtained by emulsifying each of a plurality of kinds of the rosin-based resins alone and then mixing the emulsions. Further, any of various polymers may be added to the above-mentioned emulsified product in order to further improve a sizing expression property.

[Wax]

A high-melting-point fat, an animal-based wax, a plant-based wax, a mineral-based wax, a petroleum-based wax, a blend of various waxes, or a modified product of any of various waxes is incorporated as the wax. In the present invention, any of those waxes may be used without particular limitation.

Specific examples of the wax may include: natural waxes, such as beeswax, lanolin, a carnauba wax, a candelilla wax, and a montan wax; petroleum waxes, such as a paraffin wax and a microcrystalline wax; synthetic waxes, such as a Fischer-Tropsch wax, a polyethylene wax, a polypropylene wax, and an oxidized wax; modified waxes, such as a urethane-modified wax and an alcohol-modified wax; and an α-olefin-maleic anhydride copolymer wax. Those waxes may be used alone or in combination thereof as required.

It is preferred in terms of practicality that the wax be used for the preparation of the first liquid in a state of being dispersed in an aqueous liquid. Specifically, as a method of preparing a dispersion liquid, there may be given a method involving adding the wax to an aqueous liquid and then emulsifying the mixture through use of an emulsifying apparatus, such as a universal homogenizer, a homomixer, an ultrasonic emulsifying machine, a household mixer, or a homogenizer. At the time of the emulsification, a surfactant or a polymeric dispersant is preferably used as an emulsifying agent. Those emulsifying agents may be used alone or in combination thereof.

[Polymeric Resin]

In the present invention, as the polymeric resin, there may be used any polymeric resin that exhibits water repellency in a water-repellent frame. Any monomer polymerizable by an emulsion polymerization method, a suspension polymerization method, a dispersion polymerization method, or the like may be used as a monomer for forming the polymeric resin. Examples of the polymeric resin include, depending on the kinds of monomers, acrylic, vinyl acetate-based, ester-based, ethylene-based, urethane-based, synthetic rubber-based, vinyl chloride-based, vinylidene chloride-based, and olefin-based polymeric resins.

In the present invention, as well as being used as the water-repellent component, the polymeric resin may also be used as a component for increasing the viscosity of the mixed liquid of the first liquid and the second liquid by reacting with the thickening component contained in the second liquid. Examples of such polymeric resin, which may also be used as the component for increasing the viscosity of the mixed liquid, include an anionic resin and a cationic resin. The anionic resin and the cationic resin can aggregate to increase the viscosity of the mixed liquid by reacting with a cationic compound and an anionic compound, respectively.

The anionic resin can have both of water repellency and reactivity with a cationic compound by having a hydrophobic group as well as an anionic group. An anionic polymeric resin having an anionic group and a hydrophobic group may be obtained by copolymerizing a monomer for forming the hydrophobic group (hereinafter sometimes referred to as “hydrophobic monomer”) and an anionic monomer.

The anionic monomer is not particularly limited as long as the anionic monomer is a monomer having an anionic group. For example, a hydrophilic monomer, such as (meth)acrylic acid or maleic acid, may be used as a monomer having a carboxy group. In addition, for example, styrenesulfonic acid or vinylsulfonic acid may be used as a monomer having a sulfone group. In addition, for example, vinylphosphonic acid may be used as a monomer having a phosphoric acid group.

Herein, descriptions such as “(meth)acrylic acid” and “(meth)acrylate” are meant to encompass both acrylic acid and methacrylic acid, and both acrylate and methacrylate, respectively.

The cationic resin can have both of water repellency and reactivity with an anionic compound by having a hydrophobic group as well as a cationic group. Cationic resin particles each having a cationic group and a hydrophobic group may be obtained by copolymerizing a hydrophobic monomer and a cationic monomer. In addition, such cationic resin particles may be obtained by, for example, a method involving converting a derivative of a cationic group contained in a resin having a hydrophobic group into the cationic group through an appropriate reaction.

The cationic monomer is not particularly limited as long as the cationic monomer is a monomer having a cationic group. Examples of the monomer having a cationic group include (meth)acrylate-based monomers each having an amino group, such as dimethylaminoethyl methacrylate and diethylaminoethyl acrylate. In addition, examples of the monomer having a cationic group include (meth)acrylamide-based monomers each having an amino group.

Those monomers may be N-alkyl-substituted forms or N,N-dialkyl-substituted forms, or may be products obtained by conversion into quaternary salts with halogenated hydrocarbons or the like. In general, an N,N-dialkyl-substituted form or an N,N-dialkyl-substituted form converted into a quaternary salt is preferably used. Those monomers may be used alone or as a mixture thereof.

As a hydrophobic monomer usable for the synthesis of an anionic polymeric resin or a cationic polymeric resin, there are given, for example: ester compounds of α,β-unsaturated carboxylic acids, such as ethyl (meth)acrylate, methyl (meth)acrylate, butyl (meth)acrylate, methoxyethyl (meth)acrylate, ethoxyethyl (meth)acrylate, diethylene glycol (meth)acrylate, triethylene glycol (meth)acrylate, tetraethylene glycol (meth)acrylate, polyethylene glycol (meth)acrylate, methoxydiethylene glycol (meth)acrylate, methoxytriethylene glycol (meth)acrylate, methoxytetraethylene glycol (meth)acrylate, methoxypolyethylene glycol (meth)acrylate, cyclohexyl (meth)acrylate, isobornyl (meth)acrylate, N,N-dimethylaminopropyl (meth)acrylate, monobutyl maleate, and dimethyl itaconate; alkyl amide compounds of α,β-unsaturated carboxylic acids, such as (meth)acrylamide, dimethyl (meth)acrylamide, N,N-dimethylethyl (meth)acrylamide, N,N-dimethylpropyl (meth)acrylamide, isopropyl (meth)acrylamide, diethyl (meth)acrylamide, (meth)acryloylmorpholine, maleic acid monoamide, and crotonic acid methylamide; α,β-ethylenically unsaturated compounds each having an aryl group, such as styrene, α-methylstyrene, vinyl phenylacetate, benzyl (meth)acrylate, and 2-phenoxyethyl (meth)acrylate; and ester compounds of polyfunctional alcohols, such as ethylene glycol diacrylate and polypropylene glycol dimethacrylate. Those monomers may be used alone or in combination thereof. When two or more kinds of hydrophobic monomers are used in combination, these monomers may form a random copolymer or a block copolymer.

Specifically, for example, a urethane resin may be used as the polymeric resin. The urethane resin is a resin synthesized by allowing a polyisocyanate, which is a compound having two or more isocyanate groups, to react with a polyol compound, which is a compound having two or more hydroxyl groups. In the present invention, any urethane resin obtained by allowing a known polyisocyanate compound to react with a known polyol compound may be used as long as the urethane resin satisfies the condition for the polymeric resin described above.

Examples of the structure of each of resin particles that are a dispersion of the polymeric resin in the first liquid include a single-layer structure and a multilayer structure such as a core-shell structure. In the present invention, resin particles each having a multilayer structure are preferably used. In particular, resin particles each having a core-shell structure are more preferably used. When the resin particles each have the core-shell structure, functions can be clearly separated between the core portion and shell portion thereof. Accordingly, the resin particles each having such core-shell structure have an advantage of being capable of imparting more functions to the first liquid than the resin particles each having the single-layer structure.

(Water-Soluble Resin)

The first liquid preferably further contains a water-soluble resin. The “water-soluble resin” refers to a resin capable of dissolving in water. The solubility of the water-soluble resin in water at 25° C. is preferably 1% by mass or more. In addition, the water-soluble resin may have its solubility increased by adding a water-soluble organic solvent to water, and be used by being dissolved in an aqueous medium.

When the first liquid further contains the water-soluble resin, the water-repellent component and the water-soluble resin are brought into a mixed state. When the first liquid and the second liquid are mixed under that state, the water-soluble resin and the water-repellent component aggregate together to increase the viscosity quickly, to thereby enable a precise frame to be formed. Accordingly, the water-soluble resin contained in the first liquid preferably has a property of contributing to increasing the viscosity when the first liquid and the second liquid are mixed.

Meanwhile, when the amount of the water-soluble resin in the first liquid is excessive, the water repellency of the water-repellent frame is reduced in some cases. Accordingly, there is an appropriate range for the content of the water-soluble resin in the first liquid. For the content of the water-soluble resin in the first liquid, an appropriate range in which the improvement of viscosity increase efficiency and the suppression of the reduction in water repellency can both be achieved may be determined by investigating in advance the relative content ratio thereof in the mixed liquid with respect to the water-repellent component and thickening component to be used together therewith.

In particular, the water-soluble resin is preferably at least one selected from the group consisting of an anionic water-soluble resin and a cationic water-soluble resin.

[Anionic Water-Soluble Resin]

In the present invention, for example, a water-soluble resin having an anionic group and having an acid value of from 50 mgKOH/g to 300 mgKOH/g may be used. Examples of the anionic group include a carboxy group (—COOH), a sulfonic acid group (—SO₃H), and a phosphoric acid group (—PO₄H), and one or more kinds thereof may be used.

The anionic water-soluble resin is obtained by, for example, a method involving polymerizing a monomer having an anionic group, or a method involving converting a derivative of an anionic group in a water-soluble resin into the anionic group through an appropriate reaction.

The monomer having an anionic group is not particularly limited. For example, a hydrophilic monomer, such as acrylic acid, methacrylic acid, or maleic acid, may be used as a monomer having a carboxy group. In addition, for example, styrenesulfonic acid or vinylsulfonic acid may be used as a monomer having a sulfonic acid group. In addition, for example, vinylphosphonic acid may be used as a monomer having a phosphoric acid group.

In addition, the anionic water-soluble resin may have a nonionic hydrophilic organic group. When the anionic water-soluble resin has the nonionic hydrophilic organic group, its solubility in a medium can be controlled. An example of the nonionic hydrophilic organic group may be a polyalkyleneoxy group.

A monomer having the nonionic hydrophilic organic group is not particularly limited. As a monomer having the polyalkyleneoxy group, there may be given, for example, triethylene glycol (meth)acrylate, polyethylene glycol (meth)acrylate, methoxytriethylene glycol (meth)acrylate, methoxypolyethylene glycol (meth)acrylate, phenoxytriethylene glycol (meth)acrylate, and phenoxypolyethylene glycol (meth)acrylate.

In addition, the anionic water-soluble resin preferably has a hydrophobic group as well as an anionic group. Through control of a ratio between the anionic group and the hydrophobic group, the solubility of the anionic water-soluble resin in an aqueous medium can be controlled.

For example, the anionic water-soluble resin having a hydrophobic group may be obtained by copolymerizing a monomer having a hydrophobic group and a monomer having an anionic group. The monomer having a hydrophobic group is not particularly limited, but there may be used, for example, the following known monomers each having a hydrophobic group: ester compounds of α,β-unsaturated carboxylic acids, such as ethyl (meth)acrylate, methyl (meth)acrylate, butyl (meth)acrylate, methoxyethyl (meth)acrylate, ethoxyethyl (meth)acrylate, cyclohexyl (meth)acrylate, isobornyl (meth)acrylate, N,N-dimethylaminopropyl (meth)acrylate, monobutyl maleate, and dimethyl itaconate; α,β-ethylenically unsaturated compounds each having an aryl group, such as benzyl (meth)acrylate and 2-phenoxyethyl (meth)acrylate; and as well, styrene and styrene derivatives.

In addition, the water solubility of the anionic water-soluble resin may be controlled using a base such as KOH.

[Cationic Water-Soluble Resin]

In the present invention, a water-soluble resin having a cationic group with an amine value of from 150 mgKOH/g to 300 mgKOH/g may be used. The cationic group may be any of, for example, a primary amino group (—NH₂), a secondary amino group (—NHR), a tertiary amino group (—NR₂), and structures obtained by turning those groups into ammonium cations. Of those, a tertiary amine, or a structure obtained by turning a tertiary amine into a quaternary ammonium cation is preferred as the cationic group. In the case of a primary or secondary amine, or a structure obtained by quaternizing such amine, the amino group has nucleophilicity, and hence may react with another component in ink.

The cationic water-soluble resin is obtained by, for example, a method involving polymerizing a monomer having a cationic group, or a method involving converting a derivative of a cationic group contained in a water-soluble resin into the cationic group through an appropriate reaction.

The monomer having a cationic group is not particularly limited. Examples of the monomer having a cationic group include: (meth)acrylate-based monomers each having an amino group, such as dimethylaminoethyl methacrylate and diethylaminoethyl acrylate; and (meth)acrylamide-based monomers each having an amino group.

Those monomers may be N-alkyl-substituted forms or N,N-dialkyl-substituted forms, or may be products obtained by conversion into quaternary salts with halogenated hydrocarbons or the like. In general, an N,N-dialkyl-substituted form or an N,N-dialkyl-substituted form converted into a quaternary salt is preferably used. Those monomers may be used alone or as a mixture thereof.

In addition, the cationic water-soluble resin may have a nonionic hydrophilic organic group. This is because, when the cationic water-soluble resin has the nonionic hydrophilic organic group, its solubility in a medium can be controlled. An example of the nonionic hydrophilic organic group may be a polyalkyleneoxy group. A monomer having the nonionic hydrophilic organic group is not particularly limited. As a monomer having the polyalkyleneoxy group, there may be given, for example, triethylene glycol (meth)acrylate, polyethylene glycol (meth)acrylate, methoxytriethylene glycol (meth)acrylate, methoxypolyethylene glycol (meth)acrylate, phenoxytriethylene glycol (meth)acrylate, and phenoxypolyethylene glycol (meth)acrylate.

In addition, the cationic water-soluble resin preferably has a hydrophobic group as well as a cationic group. Through control of a ratio between the cationic group and the hydrophobic group, the solubility of the cationic water-soluble resin in an aqueous medium can be controlled. The cationic water-soluble resin having a cationic group and a hydrophobic group may be obtained by, for example, copolymerizing a monomer having a hydrophobic group and a monomer having a cationic group. The monomer having a hydrophobic group is not particularly limited, but there may be used, for example, the following known monomers having a hydrophobic group: ester compounds of α,β-unsaturated carboxylic acids, such as ethyl (meth)acrylate, methyl (meth)acrylate, butyl (meth)acrylate, methoxyethyl (meth)acrylate, ethoxyethyl (meth)acrylate, cyclohexyl (meth)acrylate, isobornyl (meth)acrylate, N,N-dimethylaminopropyl (meth)acrylate, monobutyl maleate, and dimethyl itaconate; α,β-ethylenically unsaturated compounds each having an aryl group, such as benzyl (meth)acrylate and 2-phenoxyethyl (meth)acrylate; and as well, styrene and styrene derivatives.

In addition, the water solubility of the cationic water-soluble resin may be controlled using an acid such as hydrochloric acid.

<Second Liquid Containing Thickening Component and being Aqueous>

The second liquid contains a thickening component for increasing the viscosity of the mixed liquid of the first liquid and the second liquid. The thickening component thickens the mixed liquid by being brought into contact with a component in the first liquid when the second liquid is brought into contact with the first liquid and mixed therewith.

(Thickening Component)

The thickening component preferably includes a component that undergoes, with a component contained in the first liquid, at least any one interaction selected from the group consisting of: an electrostatic interaction; a hydrophobic interaction; and formation of a hydrogen bond. The thickening component may be a component that directly interacts with the water-repellent component contained in the first liquid, or, when the first liquid contains a water-soluble resin, may be a component that interacts with the water-soluble resin.

By virtue of the second liquid containing the thickening component, the viscosity of the mixed liquid obtained by mixing the first liquid and the second liquid can be increased, and hence the spread of the mixed liquid on the biological sample or the substrate can be suppressed. Consequently, a precise water-repellent frame can be formed, and many kinds of staining can be performed on one sample. In addition, the outflow of the staining solution to a portion where the object to be stained is absent can be suppressed to enable the staining solution to be effectively used.

An example of the thickening component is a component that changes the dispersibility or solubility of a component contained in the first liquid like an organic solvent such as ethanol. When the first liquid contains a cationic resin, the thickening component preferably includes an anionic resin. In this case, the cationic resin preferably includes the water-repellent component or the water-soluble resin. When the first liquid contains an anionic resin, the thickening component includes at least any one kind selected from the group consisting of: a polyvalent metal ion; an organic acid; and a cationic resin. In this case, the anionic resin preferably includes the water-repellent component or the water-soluble resin.

Any organic solvent may be used as the organic solvent as long as the organic solvent provides an effect as a thickening component. Examples of the organic solvent include: alcohols, such as ethanol and isopropanol; hydrocarbons such as n-hexane; and ethers such as diethyl ether.

Examples of the polyvalent metal ion include: divalent metal ions, such as Ca²⁺, Cu²⁺, Ni²⁺, Mg²⁺, Sr²⁺, Ba²⁺, and Zn²⁺; and trivalent metal ions, such as Fe³⁺, Cr³⁺, Y³⁺, and Al³⁺. A polyvalent metal salt (which may be a hydrate) made up of the polyvalent metal ion and an anion bonded to each other may be used to incorporate the polyvalent metal ion into the second liquid. Examples of such anion may include: inorganic anions, such as Cl⁻, Br⁻, I⁻, ClO⁻, ClO₂⁻, ClO₃⁻, ClO₄⁻, NO₂⁻, NO₃⁻, SO₄²⁻, CO₃²⁻, HCO₃⁻, PO₄³⁻, HPO₄²⁻, and H₂PO₄⁻; and organic anions, such as HCOO⁻, (COO⁻)₂, COOH(COO⁻), CH₃COO⁻, C₂H₄(COO⁻)₂, C₆H₅COO⁻, C₆H₄(COO⁻)₂, and CH₃SO₃⁻. The second liquid containing the polyvalent metal ion reacts with an anionic group of a component present in the first liquid to aggregate the component in the first liquid through salting-out.

For example, the following organic acids may each be used as the organic acid: monocarboxylic acids, such as formic acid, acetic acid, propionic acid, butyric acid, benzoic acid, glycolic acid, lactic acid, salicylic acid, pyrrolecarboxylic acid, furancarboxylic acid, picolinic acid, nicotinic acid, thiophenecarboxylic acid, levulinic acid, and coumalic acid, and salts thereof; dicarboxylic acids, such as oxalic acid, malonic acid, succinic acid, glutaric acid, adipic acid, maleic acid, fumaric acid, itaconic acid, sebacic acid, phthalic acid, malic acid, and tartaric acid, and salts and hydrogen salts thereof, tricarboxylic acids, such as citric acid and trimellitic acid, and salts and hydrogen salts thereof, and tetracarboxylic acids such as pyromellitic acid, and salts and hydrogen salts thereof. The second liquid containing the organic acid has a buffering capacity in an acidic pH region of less than 7.0, preferably a pH region of from 2.0 to 5.0, and hence turns an anionic group of a component present in the first liquid into an acid form to aggregate the component in the first liquid.

Examples of the cationic resin to be used as the thickening component may include: a resin having the structure of a primary to tertiary amine; and a resin having the structure of a quaternary ammonium salt. Specific examples thereof may include resins having such structures as vinylamine, allylamine, vinylimidazole, vinylpyridine, dimethylaminoethyl methacrylate, ethyleneimine, guanidine, and L-lysine.

In addition, an example of the anionic resin to be used as the thickening component may be a resin having an anionic group. Examples of the anionic group include a carboxy group, a sulfonic acid group, and a phosphoric acid group. The anionic resin having an anionic group is obtained by, for example, polymerizing a monomer having an anion group, or converting a derivative of an anionic group into the anionic group through a reaction.

When the cationic resin or the anionic resin is used as the thickening component, the thickening component preferably include at least any one kind selected from the above-mentioned water-repellent components and the above-mentioned water-soluble resins. That is, the cationic resin among the polymeric resins described as the water-repellent component contained in the first liquid and the cationic water-soluble resin among the water-soluble resins that the first liquid may contain may each be used as the cationic resin to be used as the thickening component.

In addition, the anionic resin among the polymeric resins described as the water-repellent component contained in the first liquid and the anionic water-soluble resin among the water-soluble resins that the first liquid may contain may each be used as the anionic resin to be used as the thickening component.

(Water-Repellent Component)

The second liquid preferably contains the water-repellent component described as a component that the first liquid contains.

In order to make a water-repellent frame as strong as possible, it is conceivable to increase the content of the water-repellent component in the first liquid. However, when the content of the water-repellent component in the first liquid is excessively high, there occur: a case in which the viscosity of the first liquid is increased to make its handling difficult at the time of the creation of the water-repellent frame; and a case in which the dispersion state of the water-repellent component in the first liquid becomes unstable. Accordingly, the content of the water-repellent component that the first liquid can contain is limited.

In the case in which the second liquid contains the water-repellent component, when the first liquid and the second liquid are mixed to form a water-repellent frame, the amount of the water-repellent component can be increased as a result. Thus, the water-repellent frame can be made strong while the content of the water-repellent component in the first liquid is set to fall within an appropriate range.

The water-repellent component contained in the second liquid is preferably a component that functions as a thickening component. When the water-repellent component contained in the second liquid functions as a thickening component, the water-repellent component contained in the first liquid and the water-repellent component contained in the second liquid interact to form a water-repellent frame. Thus, a stronger water-repellent frame can be formed.

When the second liquid contains a thickening component other than the water-repellent component, it is preferred that the water-repellent component contained in the second liquid and the thickening component be a non-interacting or weakly interacting combination. Thus, an increase in viscosity of the second liquid can be suppressed to facilitate its handling at the time of the creation of a water-repellent frame, and in addition, the dispersion state of the water-repellent component in the second liquid becomes stable.

<Relative Ratio Between Water-Repellent Component in First Liquid and Thickening Component in Second Liquid>

When the thickening component contained in the second liquid is any one of an organic solvent, a polyvalent metal ion, and an organic acid, it is preferred that the concentration of the thickening component in the second liquid be set to be high relative to the water-repellent component in the first liquid, or that the application amount of the second liquid be set to be large. Thus, the viscosity of the mixed liquid can be reliably increased, and the water-repellent frame can be efficiently created. In this case, the amount of the thickening component to be applied together with the second liquid is set within such a range as not to influence the biological sample or the staining solution.

When the thickening component contained in the second liquid is a cationic resin or an anionic resin, the first liquid and the second liquid are preferably applied so that an appropriate ratio is achieved between the component in the first liquid that interacts with the thickening component and the thickening component in the second liquid. With this, the viscosity of the mixed liquid increases quickly to enable efficient creation of the water-repellent frame. When one of the above-mentioned component in the first liquid or the thickening component of the second liquid is excessive, the increase in viscosity of the mixed liquid becomes slow in some cases. In this case, the mixed liquid spreads before the viscosity increases, and hence there occur: a case in which it becomes difficult to form a precise frame; a case in which the height of the water-repellent frame is reduced, and hence a sufficient amount of the staining solution cannot be held; and a case in which the water repellency of the water-repellent frame is not sufficiently exhibited, and hence the staining solution is liable to soak into the frame.

When the combination of the thickening component in the second liquid and the component in the first liquid that interacts with the thickening component is a cationic resin and an anionic resin, the appropriate ratio may be determined by calculation from the amine value of the cationic resin and the acid value of the anionic resin.

In addition, the ratio at which the viscosity can be most effectively increased may be experimentally determined by mixing the first liquid and the second liquid at varying ratios between their amounts, and then measuring the viscosity.

(Aqueous Medium)

The first liquid and the second liquid to be used in the present invention are each a liquid obtained by dissolving or dispersing the respective components in water or an aqueous medium obtained by mixing water and a water-soluble organic solvent. Deionized water or ion-exchanged water is preferably used as the water.

As the water-soluble organic solvent, there may be used, for example, alcohols, alkylene glycols and multimers thereof, glycol ethers, nitrogen-containing compounds, and sulfur-containing compounds, and one kind or two or more kinds thereof may be incorporated.

[Other Component]

The first liquid and the second liquid to be used in the present invention may contain various additives, such as an antifoaming agent, a surfactant, a pH-adjusting agent, a viscosity-adjusting agent, a rust inhibitor, an antiseptic, a fungicide, an antioxidant, and a reduction inhibitor, in addition to the above-mentioned components as required. In addition, as required, coloring materials, such as a pigment and a dyestuff, may each be used as an additive in order to allow the water-repellent frame to be seen with ease.

<Method of Applying First Liquid and Second Liquid>

In the present invention, the first liquid is ejected in a first liquid application step and the second liquid is ejected in a second liquid application step, respectively. Each of the first liquid and the second liquid may be applied with any one of a pipette, a capillary, a dispenser, and the like. In addition, each of the first liquid and the second liquid may also be applied using a liquid ejection head of an inkjet system mounted on an inkjet recording apparatus or the like. Among these, the first liquid and the second liquid are preferably applied using a liquid ejection head of an inkjet system.

Examples of the liquid ejection head of an inkjet system include: a mode configured to eject a liquid by causing film boiling to occur in the liquid with an electro-thermal converter to form air bubbles; a mode configured to eject a liquid with an electro-mechanical converter; and a mode configured to eject a liquid through utilization of static electricity. In the present invention, a known liquid ejection head of an inkjet system may be used. Of those, in particular, from the viewpoint of ejecting the liquid at high speed and high density, a liquid ejection head of an inkjet system utilizing an electro-thermal converter is suitably used. The liquid ejection head of an inkjet system can apply a required liquid amount to each position by receiving an image signal in accordance with the shape of the water-repellent frame.

The application of a liquid with the liquid ejection head of an inkjet system can be performed in an extremely small amount. Accordingly, when the first liquid and the second liquid are brought into contact with each other, a change in viscosity occurs quickly. In addition, the liquid can be applied to any position, and hence the water-repellent frame can be created at any position.

In the present invention, when the first liquid and the second liquid are mixed, the viscosity of the mixed liquid is increased, and thus its spread on the biological sample or the substrate can be suppressed, to thereby enable the formation of a precise water-repellent frame. Accordingly, no matter by which method the application is performed, it is important that a time difference between the application of the first liquid and the application of the second liquid be as small as possible.

<Object on which Water-Repellent Frame is Formed>

In pathological staining, cell staining is performed under a state in which a sliced specimen is placed on a slide glass as a substrate in many cases. However, the substrate to be used in the staining method according to the present invention is not limited to the slide glass. The present invention is also applicable to a case in which cell staining is performed under a state in which a biological sample such as a tissue, after having been sliced, is placed on paper, a plastic, a metal, a rubber, a ceramic, or the like. In addition, the present invention is also applicable to a case in which a biological sample such as a tissue is not sliced, and is stained by directly applying a staining solution to the biological sample.

<Staining Solution>

A staining solution contains a staining agent for staining a biological sample. A staining agent to be generally used for a biological sample is applicable as a staining agent.

As a staining agent to be used for dye staining, there are given, for example, haematoxylin, eosin, carmine, coomassie blue, crystal violet, 2-(4-amidinophenyl)-1H-indole-6-carboxamidine (DAPI), ethidium bromide, acid fuchsine, malachite green, methyl green, methylene blue, Nile blue, Nile red, rhodamine, and safranin. Other staining agents to be used for various kinds of staining, such as PAS staining, Gram staining, and Giemsa staining, may each be used.

In addition, as a staining agent to be used for immunostaining, there are given, for example, antibodies, such as anti-immunoglobulin, anti-IgG, anti-IgM, anti-IgA, and anti-IgE antibodies. An antibody bound to an enzyme, such as a peroxidase or an alkaline phosphatase, or an antibody labeled with biotin, magnetic particles, a fluorescent molecule, or the like may also be used. An antibody fragment, such as a Fab fragment obtained by papain digestion or a F(ab′)2 fragment obtained by pepsin digestion, may also be used. When the labeled antibody is, for example, a peroxidase, diaminobenzidine or the like is used as a staining substrate. A protease to be used for pretreatment, a blocking agent, or the like may also be used.

As a staining agent to be used in in situ hybridization, there are given a DNA probe and an RNA probe, which are used as probes. A probe labeled with a fluorescent molecule, digoxigenin, dinitrophenyl, or the like may also be used. Further, an anti-digoxigenin antibody, an anti-dinitrophenyl antibody, a peroxidase-bound antibody that binds to an anti-digoxigenin antibody, or the like may also be used. When the labeled antibody is, for example, a peroxidase, diaminobenzidine or the like is used as the staining substrate. A protease to be used for pretreatment, a blocking agent, or the like may also be used.

(Aqueous Medium)

A staining solution preferably contains an aqueous medium for holding the staining solution in the water-repellent frame. The aqueous medium preferably includes water. As the water, deionized water and ion-exchange water are preferably used. The content (% by mass) of water in the staining solution is preferably 25.0% by mass or more and 99.0% by mass on a basis of total mass of the staining solution.

In addition, the aqueous medium preferably contains a water-soluble organic solvent together with water for the improvement of stainability and shortening of staining time. Here, the water-soluble organic solvent is defined as the organic solvent having solubility to water at 20° C. of 200 g/L or more. The content (% by mass) of the water-soluble organic solvent based on the total mass of the staining solution is preferably 75.0% by mass or less.

As the water-soluble organic solvent, alcohols, (poly)alkylene glycols, glycol ethers, nitrogen-containing compounds, sulfur-containing compounds can be mentioned.

In addition, as the aqueous medium, a solution obtained by solubilizing a water-soluble organic compound being solid at 25° C. in water can be used. As the water-soluble organic compound being solid at 25° C., for example, a urea and a derivative thereof, a polyethylene glycol having an average molecular weight of 1000 or more, a trimethylolpropane, and a trimethylolethane can be mentioned.

(Buffer Solution)

The staining solution preferably contains a buffer solution. A change of pH of the staining solution can be suppressed and a stainability become stable by using a buffer solution. As the buffer solution, for example, phosphate buffer, glycine buffer, Good's buffer. Tris buffer, ammonia buffer and the like can be mentioned. When a buffer solution contains an aqueous medium, the aqueous medium is considered as a part of the aqueous medium in the staining solution.

(Salts)

The staining solution may contain salts. A staining condition can be optimized by adjusting a concentration of salts in the staining solution. As the salts, for example, sodium salts such as sodium chloride, potassium salts such as potassium chloride, and magnesium salts such as magnesium chloride can be mentioned.

(Other Components)

As the other components than those mentioned above, the staining solution can contain various additives such as antifoaming agents, surfactants, pH adjusters, viscosity adjusters, rust inhibitors, antiseptics, anti-mold agents, antioxidants, anti-reduction agents, and chelating agents, as necessary.

<Method of Using Water-Repellent Frame in Staining>

In the staining of a biological sample, a specimen subjected to appropriate staining for performing a pathological diagnosis is obtained through a number of steps. Now, an example of a method of using a water-repellent frame at the time of immunostaining in a specimen embedded in paraffin is described.

In the specimen embedded in paraffin, its embedding agent is removed using xylene, ethanol, 90% ethanol, 70% ethanol, or the like to expose the specimen prior to staining. Further, antigen activation treatment, protease treatment, blocking treatment, or the like may be performed as required.

After that, while the position of the specimen is checked, the first liquid and the second liquid are applied to form a water-repellent frame.

After the formation of the water-repellent frame, a liquid containing a primary antibody that binds to an antigen in the specimen is dispensed, and after the passage of a desired period of time, washing treatment is performed. After that, a peroxidase-bound secondary antibody is dispensed, and a binding reaction and washing treatment are performed. Further, diaminobenzidine is dispensed, and after a reaction, washing treatment is performed. As required, counterstaining with a hematoxylin solution is performed, and then washing treatment is performed.

After desired staining, the specimen is checked through microscopic observation. As required, the specimen may be checked after a mounting operation.

This case is one example in immunostaining. When immunostaining is to be performed for a plurality of kinds of antigens, the immunostaining for the plurality of kinds of antigens may be performed by creating a plurality of water-repellent frames and dispensing primary antibodies to their sites.

The method of using the water-repellent frame according to the present invention is not limited to the technique exemplified in the foregoing. The water-repellent frame is also applicable to staining with a dye such as HE staining and staining using DNA and RNA as in in situ hybridization. In addition, when a plurality of staining methods are to be used in combination, the staining methods may be performed by creating a plurality of water-repellent frames.

According to one aspect of the present invention, the method of staining a biological sample, which can precisely create a frame for holding a staining solution at any position, and further, can heighten the frame after its creation, can be provided.

### EXAMPLES

This embodiment is described in more detail below by way of Examples and Comparative Examples. The present invention is by no means limited to the following Examples, and various modifications may be made without departing from the gist of the present invention. In the description of the following Examples, “part(s)” is by mass unless otherwise specified.

(Volume-based 50% Cumulative Particle Diameter (D₅₀))

A volume-based 50% cumulative particle diameter (D₅₀) was measured by the following method. Ion-exchanged water was added to a liquid (the first liquid or the second liquid) containing a material (water-repellent component, etc.) serving as a measurement object to prepare a sample having a solid matter content of 1.0% by mass. The prepared sample was measured for its particle diameter using a particle size analyzer based on a dynamic light scattering method (product name: “UPA-EX150”, manufactured by Nikkiso Co., Ltd.) under the following measurement conditions: SetZero: 30 seconds, number of times of measurement: 3, measurement time: 180 seconds, and refractive index: 1.5. A resin for which no particle diameter was measured by this method was judged to be a “water-soluble” resin.

(Components in First Liquid)

[Water-Repellent Components 1, 3, and 4]

AD1608 (manufactured by Seiko PMC Corporation, solid matter concentration: 25% by mass), which was a water dispersion of a weakly cationic alkyl ketene dimer, was used as a water-repellent component 1.

SUPERFLEX 620 (manufactured by DKS Co., Ltd., solid matter concentration: 30% by mass), which was a water dispersion of cationic polyurethane resin particles, was used as a water-repellent component 3.

AQUACER 539 (manufactured by BYK-Chemie Japan, solid matter concentration: 35% by mass), which was a water dispersion of nonionic wax particles, was used as a water-repellent component 4.

[Water-Repellent Component 2]

As the water-repellent component 2, a material prepared by following procedure was used.

48.8 g of AS1532 (manufactured by Seiko PMC Corporation) serving as an alkenylsuccinic anhydride (ASA) and 40 g of an emulsifying agent SP1800 (manufactured by Seiko PMC Corporation) were loaded into CLEARMIX (manufactured by M Technique Co., Ltd.) and stirred at 10,000 rpm for 10 minutes. Thus, an ASA dispersion having an ASA concentration of 15% by mass was obtained. Resin particles in the obtained dispersion had a volume-average particle diameter (D₅₀) of 500 nm.

[Water-Repellent Component 5]

As the water-repellent component 5, a material prepared by following procedure was used.

The following materials were prepared.

| | |
|---|---|
| Ester Gum AT serving as a rosin ester resin | 70 parts |
| (manufactured by Arakawa Chemical Industries, Ltd.) | |
| Aqueous solution of an anionic water-soluble resin 1 | 75 parts |
| Polyoxyethylene lauryl ether | 15 parts |
| Ion-exchanged water | 240 parts |

A mixture of those materials was heated, and while the temperature was kept at 90° C., the mixture was irradiated with an ultrasonic wave using an ultrasonic irradiation machine (product name: “5-150D Digital Sonifier”, manufactured by Branson). An irradiation time was adjusted based around 1 hour so that resin particles in a dispersion to be finally obtained had a volume-average particle diameter (D₅₀) of 250 nm. After that, the mixture was cooled to prepare a water dispersion liquid of rosin particles, in which the content of the rosin particles (solid matter) was 25.0% by mass.

[Water-Repellent Component 6]

As the water-repellent component 6, a material prepared by following procedure was used.

A solution obtained by mixing 74 parts of ion-exchanged water and 0.2 part of potassium persulfate was placed in a four-necked flask with a stirrer, a reflux condenser, and a nitrogen gas inlet tube. A liquid obtained by mixing 34 parts of butyl methacrylate, 1.5 parts of methacrylic acid, and 0.3 part of an anionic reactive surfactant (product name: AQUALON (trademark) KH-05, manufactured by DKS Co., Ltd.), and emulsifying the mixture was added dropwise to the solution under a nitrogen atmosphere over 1 hour. The solution was subjected to a polymerization reaction while being stirred at 80° C. during the dropwise addition, and was further stirred for 2 hours after the completion of the dropwise addition. Subsequently, the resultant was cooled to room temperature, and then ion-exchanged water and an aqueous potassium hydroxide solution were added. Thus, an anionic resin particle dispersion having a resin content of 40% by mass and a pH of 8.5 was obtained. The resin particles in the obtained dispersion had a volume-average particle diameter (D₅₀) of 220 nm.

[Water-Soluble Resins 1 to 3])

EPOMIN P-1000 (polyethyleneimine, manufactured by Nippon Shokubai Co., Ltd., solid matter concentration: 30% by mass) was used as a water-soluble resin 1.

A styrene-butyl acrylate-acrylic acid copolymer having a weight average molecular weight of 9,000 and an acid value of 120 mgKOH/g was used as a water-soluble resin 2.

PEG6000 was used as a water-soluble resin 3.

<Preparation of First Liquid>

Respective components shown in Table 1 were mixed and thoroughly stirred. After that, the resultant was subjected to pressure filtration through a microfilter having a pore size of 3.0 μm (manufactured by Fujifilm Corporation) to prepare each of first liquids Nos. 1 to 15. Contents in the Table 1 represent solid matter concentrations.

TABLE 1

| | Water-repellent component | | Water-soluble resin | | |
|---|---|---|---|---|---|
| First | | Content | | Content | |
| liquid | | (% by | | (% by | |
| No. | Kind | mass) | Kind | mass) | Water |
| 1 | Water-repellent | 2.5 | Water-soluble | 1 | Balance |
| | component 1 | | resin 1 | | |
| 2 | Water-repellent | 2.5 | Water-soluble | 3 | Balance |
| | component 1 | | resin 1 | | |
| 3 | Water-repellent | 2.5 | Water-soluble | 10 | Balance |
| | component 1 | | resin 1 | | |
| 4 | Water-repellent | 2.5 | — | — | Balance |
| | component 1 | | | | |
| 5 | Water-repellent | 5 | — | — | Balance |
| | component 5 | | | | |
| 6 | Water-repellent | 15 | — | — | Balance |
| | component 5 | | | | |
| 7 | Water-repellent | 10 | Water-soluble | 1 | Balance |
| | component 1 | | resin 1 | | |
| 8 | Water-repellent | 1 | Water-soluble | 1 | Balance |
| | component 1 | | resin 1 | | |
| 9 | Water-repellent | 5 | Water-soluble | 1 | Balance |
| | component 2 | | resin 1 | | |
| 10 | Water-repellent | 5 | Water-soluble | 1 | Balance |
| | component 3 | | resin 1 | | |
| 11 | Water-repellent | 5 | Water-soluble | 3 | Balance |
| | component 4 | | resin 2 | | |
| 12 | Water-repellent | 5 | Water-soluble | 3 | Balance |
| | component 5 | | resin 2 | | |
| 13 | Water-repellent | 5 | Water-soluble | 3 | Balance |
| | component 6 | | resin 2 | | |
| 14 | Water-repellent | 2.5 | Water-soluble | 1 | Balance |
| | component 1 | | resin 3 | | |
| 15 | — | — | Water-soluble | 3 | Balance |
| | | | resin 1 | | |

(Components in Second Liquid)

[Thickening Components 1 to 7]

Ethanol, citric acid, and calcium nitrate were prepared as a thickening component 1, a thickening component 2, and a thickening component 3, respectively.

EPOMIN P-1000 (polyethyleneimine, manufactured by Nippon Shokubai Co., Ltd., solid matter concentration: 30% by mass), which was the same as the water-soluble resin 1, was used as a thickening component 4.

The same styrene-butyl acrylate-acrylic acid copolymer having a weight average molecular weight of 9,000 and an acid value of 120 mgKOH/g as the water-soluble resin 2 was used as a thickening component 5.

SUPERFLEX 620 (manufactured by DKS Co., Ltd., solid matter concentration: 30% by mass), which was the same water dispersion of cationic polyurethane resin particles as the water-repellent component 3, was used as a thickening component 6.

The same anionic resin particle dispersion as the water-repellent component 6 was used as a thickening component 7.

[Water-Repellent Component A]

As the water-repellent component A, a material prepared by following procedure was used.

0.3 Part of potassium persulfate and 74.0 parts of ion-exchanged water were mixed to prepare a solution. In addition, the following materials were prepared.

| | | |
|---|---|---|
| Ethyl methacrylate | 23.0 | parts |
| Methoxypolyethylene glycol methacrylate (Blemmer | 2.3 | parts |
| PME1000, manufactured by NOF Corporation) | | |
| Nonionic reactive surfactant (NIKKOL BC15, | 0.4 | part |
| manufactured by Nikko Chemicals Co., Ltd.) | | |

Those materials were mixed to prepare an emulsion. Under a nitrogen atmosphere, the emulsion was added dropwise to the above-mentioned solution over 1 hour, and the mixture was subjected to a polymerization reaction while being stirred at a temperature of 80° C., and was further stirred for 2 hours. The resultant was cooled to room temperature, and then ion-exchanged water and an aqueous potassium hydroxide solution were added to provide a liquid containing dispersed particles of a nonionic resin serving as a water-repellent component A (resin content: 25.0% by mass). The nonionic resin particles had a volume-average particle diameter (D₅₀) of 70 nm.

<Preparation of Second Liquid>

Respective components shown in Table 2 were mixed and thoroughly stirred. After that, the resultant was subjected to pressure filtration through a microfilter having a pore size of 3.0 μm (manufactured by Fujifilm Corporation) to prepare each of second liquids Nos. 1 to 13. Numbers in the Table 2 represent solid matter concentrations.

TABLE 2

| | | | Water- | Water- | |
|---|---|---|---|---|---|
| | | | soluble | repellent | |
| | Thickening component | | resin 3 | component A | |
| Second | | Content | Content | Content | |
| liquid | | (% by | (% by | (% by | |
| No. | Kind | mass) | mass) | mass) | Water |
| 1 | Thickening | 2.5 | — | — | Balance |
| | component 7 | | | | |
| 2 | Thickening | 5 | — | — | Balance |
| | component 7 | | | | |
| 3 | Thickening | 15 | — | — | Balance |
| | component 7 | | | | |
| 4 | Thickening | 16 | — | — | Balance |
| | component 5 | | | | |
| 5 | Thickening | 3 | — | — | Balance |
| | component 4 | | | | |
| 6 | Thickening | 8 | — | — | Balance |
| | component 5 | | | | |
| | Thickening | 2.5 | | | |
| | component 7 | | | | |
| 7 | Thickening | 3 | — | — | Balance |
| | component 4 | | | | |
| | Thickening | 5 | | | |
| | component 6 | | | | |
| 8 | Thickening | 2.5 | 1 | — | Balance |
| | component 7 | | | | |
| 9 | Thickening | 8 | — | 5 | Balance |
| | component 5 | | | | |
| 10 | Thickening | 70 | — | — | Balance |
| | component 1 | | | | |
| 11 | Thickening | 70 | 1 | — | Balance |
| | component 1 | | | | |
| 12 | Thickening | 5 | — | — | Balance |
| | component 2 | | | | |
| 13 | Thickening | 3 | — | — | Balance |
| | component 3 | | | | |

### Examples 1 to 28

10 μL of the first liquid of the No. shown in Table 3 was dropped onto a slide glass, and then 10 μL of the second liquid of the No. shown in Table 3 was dropped onto the slide glass so as to overlap the first liquid at least partially. Immediately after the dropping of the second liquid, the mixed liquid of the first liquid and the second liquid was stirred with a pipette for 10 seconds, and then thinly applied in a circular shape having a diameter of 20 mm, followed by sufficient drying at 25° C. to prepare a sample.

### Comparative Examples 1 to 4

In each of Comparative Examples 1 to 3, the first liquid of the No. shown in Table 3 was used, and no second liquid was used. In addition, in Comparative Example 4, no first liquid was used, and the second liquid used was the second liquid No. 1. Samples were prepared in the same manner as in Examples 1 to 28 except the foregoing.

<Evaluations>

In the present invention, in evaluation criteria for each of the following items, “AA”, “A”, and “B” were defined as acceptable levels, and “C” was defined as an unacceptable level.

(Staining Solution Resistance Evaluation (Aggregation Property Evaluation) of Water-Repellent Frame)

2 μL of water was dropped onto each of the samples according to Examples 1 to 28 and Comparative Examples 1 to 4 prepared in the foregoing, contact angles with respect to elapsed time were measured with an automatic contact angle meter (apparatus name: Automatic Contact Angle Meter CA-W, manufactured by Kyowa Interface Science Co., Ltd.), and evaluation was performed by the following criteria.

AA: The difference between contact angles after 0.1 second and after 15 seconds from the dropping of water is less than 5°.

A: The difference between contact angles after 0.1 second and after 15 seconds from the dropping of water is 5° or more and less than 10°.

B: The difference between contact angles after 0.1 second and after 15 seconds from the dropping of water is 10° or more and less than 20°.

C: The difference between contact angles after 0.1 second and after 15 seconds from the dropping of water is 200 or more.

The results of the evaluation are shown in Table 3.

(Water Repellency Evaluation of Water-Repellent Frame)

2 μL of water was dropped onto each of the samples according to Examples 1 to 28 and Comparative Examples 1 to 4 prepared in the foregoing, a contact angle after 15 seconds was measured with an automatic contact angle meter (apparatus name: Automatic Contact Angle Meter CA-W, manufactured by Kyowa Interface Science Co., Ltd.), and evaluation was performed by the following criteria.

AA: The contact angle after 15 seconds from the dropping of water is 800 or more.

A: The contact angle after 15 seconds from the dropping of water is 60° or more and less than 80°.

B: The contact angle after 15 seconds from the dropping of water is 30° or more and less than 60°.

C: The contact angle after 15 seconds from the dropping of water is less than 30°.

The results of the evaluation are shown in Table 3.

TABLE 3

| | First | Second | Aggregation | Water |
|---|---|---|---|---|
| | liquid | liquid | property | repellency |
| | No. | No. | evaluation | evaluation |
| Example 1 | 1 | 1 | AA | AA |
| Example 2 | 1 | 2 | AA | AA |
| Example 3 | 1 | 3 | A | A |
| Example 4 | 2 | 1 | B | AA |
| Example 5 | 2 | 2 | A | AA |
| Example 6 | 2 | 3 | AA | AA |
| Example 7 | 3 | 3 | A | A |
| Example 8 | 1 | 4 | B | B |
| Example 9 | 1 | 4 | B | A |
| Example 10 | 4 | 1 | B | A |
| Example 11 | 5 | 5 | A | A |
| Example 12 | 6 | 5 | AA | A |
| Example 13 | 1 | 6 | AA | AA |
| Example 14 | 7 | 6 | A | AA |
| Example 15 | 8 | 6 | AA | AA |
| Example 16 | 9 | 6 | AA | AA |
| Example 17 | 10 | 6 | AA | AA |
| Example 18 | 11 | 7 | AA | AA |
| Example 19 | 12 | 7 | AA | AA |
| Example 20 | 13 | 7 | AA | AA |
| Example 21 | 14 | 1 | A | A |
| Example 22 | 1 | 8 | A | A |
| Example 23 | 1 | 9 | A | A |
| Example 24 | 1 | 10 | A | A |
| Example 25 | 7 | 10 | B | B |
| Example 26 | 7 | 11 | B | B |
| Example 27 | 6 | 12 | A | A |
| Example 28 | 6 | 13 | A | A |
| Comparative Example 1 | 4 | — | C | C |
| Comparative Example 2 | 3 | — | C | C |
| Comparative Example 3 | 15 | — | C | C |
| Comparative Example 4 | — | 1 | C | C |

### Example 29

The first liquid No. 1 and the second liquid No. 1 were each loaded into a separate ink cartridge, which was set in an inkjet recording apparatus (PIXUS PRO 10-5, manufactured by Canon Inc.) mounted with a liquid ejection head of an inkjet system configured to eject ink through the action of thermal energy. In this liquid ejection head, a row of ejection ports for ejecting each of the first liquid and the second liquid is arranged along a direction orthogonal to a main-scanning direction. With use of the above-mentioned inkjet recording apparatus, first, the first liquid No. 1 was ejected from the liquid ejection head at a duty of 50% onto a CREST-coated slide glass (manufactured by Matsunami Glass Ind., Ltd.) in a circular shape having a diameter (inner diameter) of 10 mm designed to be a 1-point frame. After that, the second liquid No. 1 was ejected from the liquid ejection head at a duty of 50% to the same region, and sufficiently dried at 25° C. to prepare a sample. In this Example, an image recorded under such a condition that eight ink droplets of about 3.8 ng are applied to a unit region of 1/600 inch× 1/600 inch (1 pixel) is defined as having a recording duty of 100%.

### Comparative Example 5

A water-repellent frame in a circular shape having a diameter (inner diameter) of 10 mm was formed on a CREST-coated slide glass (manufactured by Matsunami Glass Ind., Ltd.) through use of a PAP pen (product name: Liquid Blocker, manufactured by Daido Sangyo Co., Ltd.) in which a water-repellent component was dissolved in an organic solvent. Thus, a sample was prepared.

(Liquid Holding Ability Evaluation of Water-Repellent Frame)

With respect to the water-repellent frame sample formed in a circle shape having a diameter of 10 mm designated to be a 1-point frame produced in the Example 29, following experiments were performed.

400 μL of water was dropped inside the circular water-repellent frame sample. In an observation after 10 minutes from the dropping, it was confirmed that water did not go out from the water-repellent frame sample.

Besides the water-repellent frame sample dropped with water as above, an unused water-repellent frame sample according to the Example 29 was prepared.

As a staining solution, a hematoxylin solution was prepared by mixing two liquids with each other that was provided as Tissue-Teck (trade mark) hematoxylin 3G set (manufactured by Sakura Finetek Japan Co., Ltd) accordingly to the manufacturer's instructions.

400 μL of the hematoxylin solution was dropped inside the circular water-repellent frame sample. In an observation after 10 minutes from the dropping, it was confirmed that the hematoxylin solution did not go out from the water-repellent frame sample.

Further besides the water-repellent frame samples as above, an another unused water-repellent frame sample according to the Example 29 was prepared.

As raw materials of a staining solution, a buffer solution containing 50 mM aqueous solution of Tris-base and 150 mM aqueous solution of sodium chloride, the buffer solution being prepared by adjusting pH to 7.6 with hydrochloride followed by pressure filtration with a sterile filter having a pore size of 0.22 μm, a bovine serum albumin (manufactured by Sigma Aldrich Co. LLC), and a polyclonal rabbit-derived anti-human HER2 antibody (A0485, manufactured by Dako) were provided. Her2 represents Human epidermal growth factor-2.

As a staining solution, a buffer solution with 3% of bovine serum albumin and 0.001% of the antibody was prepared using the raw materials mentioned above.

400 μL of the antibody-containing staining solution prepared as above was dropped inside the circular water-repellent frame sample. In an observation after 10 minutes from the dropping, it was confirmed that the antibody-containing staining solution did not go out from the water-repellent frame sample.

On the other hand, when water was dropped inside the water-repellent frame sample according to the Comparative Example 5 with the same conditions as those for the experiments performed using the water-repellent frame sample according to the Example 29, it was observed that water overflowed out of the water-repellent frame sample in the middle of dropping.

(Height Evaluation of Water-Repellent Frame)

For the sample prepared in Example 29, the height of the water-repellent frame was measured using a contact-type surface profiler (product name: Dektak, manufactured by Bruker), and was found to be 10 μm.

Meanwhile, for a sample prepared by being drawn once in Comparative Example 5, the height of the water-repellent frame was measured with a contact-type surface profiler (product name: Dektak, manufactured by Bruker), and was found to be 2 m. In addition, for a sample prepared by being drawn 3 times in a superimposed manner, the height of the water-repellent frame was measured, and was found to be 2 μm.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2022-107379, filed Jul. 1, 2022, and Japanese Patent Application No. 2023-103687, filed Jun. 23, 2023, which are hereby incorporated by reference herein in their entirety.

What is claimed is:

1. A method of staining a biological sample comprising:
a first liquid application step of applying a first liquid onto one of a biological sample or a substrate on which the biological sample is placed, the first liquid containing a water-repellent component and being aqueous;
a second liquid application step of applying a second liquid onto one of the biological sample or the substrate, the second liquid containing a thickening component and being aqueous; and
a staining solution application step of applying a staining solution for staining the biological sample,
wherein the first liquid and the second liquid are applied so as to overlap each other at least partially, to thereby produce a mixed liquid,
wherein the thickening component is a component for increasing a viscosity of the mixed liquid, and
wherein the first liquid application step and the second liquid application step comprise applying the first liquid and the second liquid so that the mixed liquid surrounds a region for holding the staining solution.

2. The method of staining a biological sample according to claim 1, wherein the first liquid further contains a water-soluble resin.

3. The method of staining a biological sample according to claim 1, wherein the thickening component includes a component that undergoes, with a component contained in the first liquid, at least any one interaction selected from the group consisting of: an electrostatic interaction; a hydrophobic interaction; and formation of a hydrogen bond.

4. The method of staining a biological sample according to claim 3,
wherein the first liquid contains a cationic resin, and the thickening component includes an anionic resin, or
wherein the first liquid contains an anionic resin, and the thickening component includes at least any one kind selected from the group consisting of: a polyvalent metal ion; an organic acid; and a cationic resin.

5. The method of staining a biological sample according to claim 4, wherein the thickening component includes at least any one kind selected from the group consisting of: a water-repellent component; and a water-soluble resin.

6. The method of staining a biological sample according to claim 1, wherein the water-repellent component is at least any one kind selected from the group consisting of: an alkyl ketene dimer; an alkenylsuccinic anhydride; rosin; a wax; a cationic resin; and an anionic resin.

7. The method of staining a biological sample according to claim 1, wherein the first liquid application step and the second liquid application step comprise applying the first liquid and the second liquid, respectively, through use of a liquid ejection of an inkjet system.

8. The method of staining a biological sample according to claim 1, wherein the staining solution contains an aqueous medium.
